(19) United States
(12) Patent Application Publication
(10) Pub. No.: US 2005/0138965 A1
(43) Pub. Date: Jun. 30, 2005

(54) Measurement of the electrical resistance of a molten glass

(76) Inventor: Charles John Freeman, Littleton, CO (US)

Correspondence Address: Robert D. Touslee;Johns Manville International, Inc., 10100 West Ute Avenue, Littleton, CO, 80127, US

(21) Appl. No.: 10/750,796

(22) Filed: Dec. 31, 2003

(51) Int. Cl. C03B 5/24

(52) U.S. Cl. 65/29.18

(57) ABSTRACT

A method for controlling at least one process parameter while processing a molten glass is provided. The method includes: measuring an electrical resistance of the molten glass to obtain an electrical resistance measurement; and adjusting at least one process parameter based on the electrical resistance measurement.

### BACKGROUND OF THE INVENTION

1. Field of the Invention

The present invention relates to measuring the electrical resistance of a molten glass. In particular, the present invention relates to methods for controlling at least one process parameter while processing a molten glass, by measuring an electrical resistance of such molten glass.

2. Description of the Related Art

Molten glass can be formed by introducing a raw batch material into a glass furnace and melting the raw batch material. Thereafter, the molten glass can be conveyed to additional apparatus(es) for processing into various products.

Typically, various characteristics of the molten glass and/or the process parameters in the processing of such molten glass can have an effect on the efficiency of the overall process and/or the quality of the products formed. As such, it can be desirable to monitor and/or control such characteristics of the molten glass and or process parameters. However, conventional monitoring and controlling techniques do not provide adequate means for ameliorating or overcoming particular problems associated with molten glass-manipulating processes.

For example, in a molten glass-forming process, the molten glass formed in a furnace can be conveyed to a forehearth for distributing the molten glass to a plurality of bushings or other fiberizing apparatuses. The molten glass can be drawn from the bushings, and thereafter can be subject to a cooling process. The thus-formed glass fibers can then be wound or chopped. A common problem which exists in the manufacture of such glass fibers is the breakage of the fibers when they are drawn from the bushings. Such “bushing breaks” can cause delays in the production process, and therefore can render the process less efficient. The bushing breaks can be caused by fluctuations in characteristics of the molten glass, and/or inadequate means for controlling the process parameters of the glass-forming process.

It can be desirable to provide methods for accurately controlling a process parameter in the processing of a molten glass. According to an exemplary aspect of the present invention, the occurrence of the above-described bushing breaks during the production of glass fibers can be ameliorated or overcome. Other exemplary advantages and exemplary aspects of the present invention will become apparent to one of ordinary skill in the art upon review of the specification, drawing and claims appended hereto.

### SUMMARY OF THE INVENTION

According to a first aspect of the present invention, a method for controlling at least one process parameter while processing a molten glass is provided. The method comprises: measuring an electrical resistance of the molten glass to obtain an electrical resistance measurement; and adjusting at least one process parameter based on the electrical resistance measurement.

### BRIEF DESCRIPTION OF THE DRAWING

Aspects of the present invention will become apparent from the following detailed description of preferred embodiments thereof in connection with the accompanying drawing in which:

FIG. 1 is a cross-sectional view of an exemplary sensor for measuring an electrical resistance of a molten glass, according to one aspect of the present invention.

### DETAILED DESCRIPTION OF PREFERRED EMBODIMENTS OF THE INVENTION

The methods of the present invention are suitable for use in controlling at least one process parameter while processing a molten glass. As used herein, the phrase “processing a molten glass” includes any process which involves the use or storage of molten glass. For example, the processing can include conveying, forming and/or manipulating the molten glass. More specifically, such processing can include forming a molten glass from a raw material, conveying the molten glass to a desired location, and/or forming the molten glass into a product. In an exemplary embodiment, the processing of the molten glass at least includes forming glass fibers therefrom.

The at least one process parameter in the processing of the molten glass can be controlled by measuring the electrical resistance of the molten glass in order to obtain an electrical resistance measurement. The electrical resistance measurement can then be used as the basis for adjustments made to the at least one process parameter. In a preferred embodiment, the adjustment of the at least one process parameter can affect at least one characteristic of the molten glass. Such effect on the at least one characteristic of the molten glass can, for example, improve the efficiency of the overall molten glass-manipulating process.

The molten glass as a whole can possess varying electrical resistance values at different locations thereof. For example, the presence of multiple electrical resistance values in a single mass of molten glass can be caused by varying temperature levels in the mass of molten glass. As used herein, the term “the electrical resistance” refers to the electrical resistance of the molten glass at a location where such characteristic is measured. The recitation of such term “the electrical resistance” does not necessarily mean that the molten glass is limited to having only one electrical resistance value.

The inventive methods can be used in molten glass processing applications wherein the molten glass is at a temperature range of, for example, from about 950 C to about 1450 C. While the inventive methods are not limited to use at any particular high-temperature range, it is believed that at extremely high temperature levels, for example, over 1500 C, electrical resistance variations in the molten glass can become small, and the monitoring of fluctuations in the electrical resistance of the molten glass can become difficult and/or unreliable.

The at least one process parameter can include any parameter of molten glass processing. In an exemplary embodiment, the at least one process parameter can include increasing or decreasing at least one temperature setpoint in the process. As used herein, the term “temperature setpoint” refers to a temperature value or range of temperature values which is used as a setpoint in an apparatus or system for controlling the temperature of the molten glass. For example, changing the temperature setpoint can cause an increase or decrease in the amount of heat that is provided to the molten glass, thereby affecting the temperature thereof. Heat can be provided to the molten glass using any suitable heating system or apparatus including, for example, at least one electrode and/or combustion burner.

The processing of the molten glass can include the use of one or a plurality of temperature setpoints, for example, at various locations of the molten glass. The at least one process parameter can include any combination of the temperature setpoints used in the process.

The at least one process parameter additionally or alternatively can include increasing or decreasing the amount of heat provided to the molten glass. In an exemplary embodiment, the molten glass is present in a glass melting furnace, and the at least one process parameter includes increasing or decreasing the amount of heat provided by the furnace to the molten glass. The amount of heat provided to the molten glass can be based on the furnace as a whole, and/or a particular location within the furnace. As discussed above, heat can be provided to the molten glass using any suitable heating system or apparatus.

Additionally or alternatively, the at least one process parameter can include adjusting the composition of the raw material used to form the molten glass and/or the addition of an additive to the molten glass. As used herein, the term “composition of the raw material” refers to the particular materials which make up the raw material as well as the proportions of such materials. For example, various characteristics of the molten glass can be dependent on the selection and/or proportions of the materials used to form the molten glass. By adjusting the composition of the materials used to form the molten glass, the characteristics thereof can be altered. Any suitable means for adjusting the composition of the raw material and/or adding an additive to the molten glass can be used.

In an exemplary embodiment, the adjustment of the at least one process parameter can be effective to change at least one characteristic of the molten glass. For example, the electrical resistance, temperature, viscosity and/or surface tension of the molten glass can be altered by adjusting the at least one process parameter.

While not wishing to be bound by any particular theory, it is believed that the breakage of glass fibers during the drawing of such fibers from fiberizing bushings can be attributed at least in part to fluctuations of the viscosity and/or surface tension of the molten glass used to form the fibers. In an exemplary embodiment, the use of the inventive methods can reduce or eliminate the occurrence of such bushing breaks during the formation of glass fibers by providing a means for maintaining the viscosity and/or surface tension of the molten glass within a predetermined range or at a predetermined level.

The manner in which the at least one process parameter is controlled can depend on the particular control system that is used. Any process control system which is capable of receiving process information and adjusting process parameters based on such information can be used.

In an exemplary embodiment, a control system which includes process control hardware and software can be used. The process control software can, for example, employ at least one algorithm or formula which correlates the electrical resistance measurement to the at least one process parameter. For example, the inventive methods can employ process control software which is available from Universal Dynamics Technologies located in British Columbia, Canada, under the trade name BrainWave.

In an exemplary embodiment, the electrical resistance measurement can be provided to a control system which controls various aspects of the process for manipulating the molten glass, and receives process data including the molten glass electrical resistance data. For example, the control system can control one or a plurality of process parameters. The electrical resistance measurement can be inputted as an input variable into the control system, along with various other variables including, for example, the temperature of the molten glass. The control system can then process the various input variables and adjust the one or plurality of process parameters to achieve a desired result, for example, maintaining the electrical resistance of the molten glass at a predetermined range or setpoint. Various sensors and other apparatuses can be used in conjunction with the control system in order to provide relevant process data thereto.

In one embodiment, a predetermined range or setpoint of the electrical resistance of the molten glass can be selected, and a control apparatus or system can be used to maintain the electrical resistance of the molten glass at the predetermined range or setpoint. The selection of the predetermined range or setpoint can depend on, for example, the manner in which the electrical resistance of the molten glass correlates to a particular characteristic or characteristics of the molten glass to be controlled.

For example, it can be beneficial in some processes to select a narrow predetermined range or setpoint, whereas in other processes it can be acceptable to employ a broader range or setpoint. The electrical resistance measurement can be compared with the predetermined range or setpoint, and any difference therebetween can be the basis for adjusting the at least one process parameter.

The electrical resistance measurements of the molten glass can be taken at any frequency, and the frequency can depend on the particular application. The electrical resistance can be measured on a continuous or intermittent basis. For example, the electrical resistance of the molten glass can be measured at least once per minute, more preferably once per second.

The electrical resistance can be measured using any device suitable for making such measurement. Preferably, the measuring device can withstand the high temperature levels of the molten glass for extended periods of time. In light of such high temperature levels, the measuring device can be routinely monitored and if necessary replaced to improve and/or ensure the accuracy of the electrical resistance measurements being taken.

In an exemplary embodiment, the measuring device can include at least one pair of electrodes for measuring the electrical resistance of the molten glass. Preferably, the pair of electrodes can be used to measure the electrical resistance of the molten glass by passing an electrical current, preferably a low AC current, between the two electrodes, and measuring the current and voltage across the electrodes. The resistance can be calculated as the measured voltage divided by the measured current. Such current and voltage measurements can be conducted on an intermittent or continuous basis, preferably on a continuous basis.

The measuring device can be arranged in any position suitable for measuring the electrical resistance of the molten glass. For example, the arrangement and number of measuring devices used can depend on the manner in which the molten glass is being contained and/or conveyed. The present invention can be used in processes which involve the conveyance of the molten glass along a flow path. For example, when such flow path is defined by opposing sidewalls, and a pair of electrodes or other suitable devices is used, one such electrode or device can be arranged in each opposing sidewall.

The inventive methods can be used in a process for forming a molten glass from a raw material in a furnace. Such furnaces and processes of using same are well known in the art and are discussed in, for example, U.S. Pat. Nos. 4,028,083 and 3,983,309, each of which is incorporated by reference herein. Additionally or alternatively, the inventive methods can be used in a process which includes forming a glass fiber from molten glass. Glass fiber-forming apparatuses and methods for forming glass fibers are well known in the art and are discussed in, for example, U.S. Pat. Nos. 6,453,702 and 5,935,289, each of which is incorporated by reference herein.

The molten glass employed in the present invention can be formed from any raw material useful for forming a molten glass. Preferably, the raw material enables the molten glass to be formed into a product such as a glass fiber. In a preferred embodiment, the molten glass can be used to form E-glass products. E-glass is a well-known type of glass which is useful in the manufacture of, for example, fiber glass reinforcements, nonwoven specialty mats, roofing substrates, gypsum reinforcing fibers and glass textile wall coverings.

The following is an example of the methods described above, and the present invention should not be construed as being limited to such example.

### EXAMPLE

Raw material can be introduced into a furnace for forming molten glass from the raw material. The raw material can be melted and molten glass can be formed. The molten glass can then be transported to an enclosure downstream from the furnace. The enclosure can contain at least one sensor, preferably multiple sensors, for measuring the electrical resistance of the molten glass, at particular location(s) in the enclosure. The enclosure can be located upstream from an apparatus for forming a product from the molten glass such as, for example, a glass fiberizing apparatus.

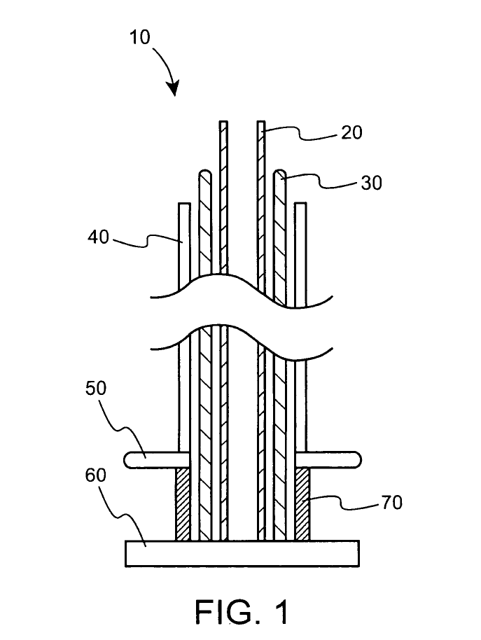

The sensor can be positioned above the molten glass, near or at the top of the enclosure, and can extend down into the molten glass. Referring to FIG. 1, the sensor 10 itself can include an outer metallic tube 40 and an inner metallic tube 20, each preferably made of platinum and rhodium. The inner and outer metallic tubes 20 and 40 can be separated by a substantially non-conductive material, for example, a ceramic tube 30. The ceramic tube 30 can prevent contact between the inner and outer metallic tubes 20 and 40. The inner and outer metallic tubes 20 and 40 and the ceramic tube 30 preferably are substantially concentrically arranged with each other.

Electrodes 60 and 50 can be connected to the inner and outer metallic tubes 20 and 40, respectively, preferably at the ends of the tubes 20 and 40 opposite the ends that are inserted into the molten glass. The electrodes 50 and 60 can each be made of platinum and rhodium. An alternating current can be used to power the sensor 10. The resistivity of the molten glass can be calculated by measuring the current and voltage across the electrodes 50 and 60.

The electrical resistance of the molten glass can be monitored over a period of time using the above-described sensor 10. When the electrical resistance deviates from a predetermined range or level, at least one process parameter such as a temperature setpoint or the amount of heat provided to the furnace or enclosure, can be adjusted based on the electrical resistance measurement to return the electrical resistance of the molten glass to the predetermined range or level.

While the invention has been described with reference to preferred embodiments, it is understood that variations and modifications may be resorted to as will be apparent to those skilled in the art. Such variations and modifications are to be considered within the purview and scope of the invention as defined by the claims appended hereto.

1. Method for controlling at least one process parameter while processing a molten glass, comprising:
measuring an electrical resistance of the molten glass to obtain an electrical resistance measurement; and
adjusting at least one process parameter based on the electrical resistance measurement.

2. The method of claim 1, wherein the step of adjusting the at least one process parameter is effective to control a characteristic of the molten glass.

3. The method of claim 2, wherein the step of adjusting the at least one process parameter is effective to control a viscosity of the molten glass.

4. The method of claim 1, wherein the electrical resistance is measured with at least one pair of electrodes.

5. The method of claim 1, wherein the at least one process parameter is controlled during a process for forming the molten glass, wherein the process comprises melting a raw material in a furnace to form the molten glass.

6. The method of claim 5, wherein after formation of the molten glass, the molten glass is conveyed to an apparatus for forming a glass fiber from the molten glass.

7. The method of claim 1, wherein the measuring and adjusting steps are conducted prior to conveying the molten glass to an apparatus for forming a glass fiber from the molten glass.

8. The method of claim 1, wherein the step of adjusting the at least one process parameter comprises increasing or decreasing a temperature setpoint in the processing of the molten glass.

9. The method of claim 1, wherein the molten glass is present in an enclosure, and the step of adjusting the at least one process parameter comprises increasing or decreasing an amount of heat that the enclosure provides to the molten glass.

10. The method of claim 5, wherein the step of adjusting the at least one process parameter comprises altering a composition of the raw material used to form the molten glass.

11. The method of claim 1, wherein the step of adjusting the at least one process parameter is effective to maintain the electrical resistance of the molten glass in a predetermined range or at a predetermined level.

12. The method of claim 1, wherein a plurality of process parameters are adjusted based on the electrical resistance measurement.
